(19) United States
(12) Patent Application Publication
(10) Pub. No.: US 2017/0204908 A1
(43) Pub. Date: Jul. 20, 2017

(54) BALL BEARING

(71) Applicant: JTEKT CORPORATION, Osaka-shi, Osaka (JP)

(72) Inventors: Yasuhiko ISHII, Kashiwara-shi (JP); Takashi IWATA, Kitakatsuragi-gun (JP)

(73) Assignee: JTEKT CORPORATION, Osaka-shi, Osaka (JP)

(21) Appl. No.: 15/326,149

(22) PCT Filed: Jul. 15, 2015
(86) PCT No.: PCT/JP2015/070214

§ 371 Date: Jan. 13, 2017

(30) Foreign Application Priority Data
Jul. 16, 2014 (JP) 2014-145848

(51) Int. Cl. F16C 33/66; F16C 33/78; F16C 33/58; F16C 19/06; F16C 33/38

(52) U.S. Cl. CPC F16C 33/6614; F16C 19/06; F16C 33/38; F16C 33/58; F16C 33/78

(57) ABSTRACT

A ball bearing includes an inner ring including an inner ring raceway surface on an outer periphery, an outer ring including an outer ring raceway surface on an inner periphery, a plurality of balls arranged between the inner ring raceway surface and the outer ring raceway surface, and a retainer including a plurality of pocket holes which respectively store the plurality of the balls, and arranged between the inner ring and the outer ring. Grease is sealed between the inner ring and the outer ring. The inner periphery of the outer ring is contacted with outer peripheral surface of the retainer so as to guide the retainer. The inner periphery of the outer ring includes a grease storage groove which communicates with the outer ring raceway surface, only on one side in an axial direction of the outer ring with respect to the outer ring raceway surface.

### TECHNICAL FIELD

The invention relates to a grease lubrication ball bearing.

### BACKGROUND ART

As a method for lubricating a ball bearing, there is widely used a grease lubrication method. Also, as a method for guiding a retainer of the ball bearing, there is known, for example, an outer ring guide method for rotating the retainer while the outside diameter of the retainer is guided by the inner peripheral surface of an outer ring. The grease lubrication ball bearing employing the outer ring guide method is proposed in, for example, the below-cited patent literature 1.

The patent literature 1 discloses a grease lubrication high-speed rotation ball bearing which includes an inner ring, an outer ring, a plurality of balls interposed between the inner and outer rings, and a retainer for holding the plurality of the balls at specific intervals along the peripheral direction. In the ball bearing of the patent literature 1, the inner periphery of the rotating outer ring and the outer periphery of the retainer are brought into sliding contact with each other. Also, in the patent literature 1, in order to secure lubrication in the balls and outer ring raceway surface, there is proposed a structure in which grease storage grooves are formed on both sides of the outer ring raceway surface of the inner peripheral surface of the outer ring. Specifically, in the inner peripheral surface of the outer ring, on one side in the axial direction of the outer ring with respect to the outer ring raceway surface, there is formed a deep groove type grease storage groove, whereas, on the other side in the axial direction of the outer ring with respect to the outer ring raceway surface, there is formed a shallow groove type grease storage groove

### PRIOR ART TECHNOLOGY DOCUMENT

### Patent Literature

### [Patent Literature 1] JP-A-2010-164122

### DISCLOSURE OF THE INVENTION

### Problems that the Invention is to Solve

As in the patent literature 1, when the deep groove type grease storage groove and shallow groove type grease storage groove are formed on both sides of the outer ring inner peripheral surface with respect to the raceway surface thereof, in order to form the grease storage grooves while preventing the lowered strength of the outer ring, the thickness of the inner periphery of the outer ring is increased toward the inside diameter side to form a shoulder part, thereby forming two grease storage grooves.

However, in such thickness increasing structure, due to the increased thickness of the inner peripheral surface of the outer ring, the area of a space lying between the inner and outer rings of the ball bearing is reduced. Thus, the quantity of grease to be sealed between the inner and outer rings is reduced, thereby raising a fear that the life of the ball bearing can be shortened.

Also, in the structure of the patent literature 1, such intermediate part of the outer peripheral surface of the retainer as exists nearer to the end than the pocket hole is opposed to the end edge of the grease storage groove. In the outer ring guide method, since the outer peripheral surface of the retainer and the inner peripheral surface of the outer ring are contacted with each other, there is a fear that only such part of the outer peripheral surface of the retainer as exists nearer to the end than the pocket hole can be contacted with the inner peripheral surface of the outer ring and thus only such part can be worn abnormally.

When such partial wear occurs on the outer peripheral surface of the retainer, the balance between one side and the other side of the retainer in the axial direction is worsened and thus, during rotation of the retainer, there is a fear of occurrence of a rocking phenomenon that the retainer rotates while the center thereof is whirling. Particularly, in the ball bearing which rotates at high speeds, there is a fear that the rocking of the retainer can be actualized further.

Thus, the invention has an object to provide a ball bearing which can realize excellent grease lubrication over a long period and also can prevent occurrence of partial wear in the outer peripheral surface of a retainer.

### Means for Solving the Problems

The invention provides a ball bearing (1; 101) comprising an inner ring (2) including an inner ring raceway surface (11) on an outer periphery, an outer ring (3) including an outer ring raceway surface (15) on an inner periphery, a plurality of balls (4) arranged between the inner ring raceway surface and the outer ring raceway surface, and a retainer (5) including a plurality of pocket holes (27) which respectively store the plurality of the balls and arranged between the inner ring and the outer ring. Grease is sealed between the inner ring and the outer ring. The inner periphery of the outer ring is contacted with outer peripheral surface (28) of the retainer so as to guide the retainer. The inner periphery of the outer ring includes a grease storage groove (20) which stores the grease therein, only on one side in an axial direction (X) of the outer ring with respect to the outer ring raceway surface. The grease storage groove communicates with the outer ring raceway surface. An end edge (40) of the grease storage groove on the one side in the axial direction is flush with end parts of peripheral walls (30) of the plurality of the pocket holes on one side in the axial direction or arranged in a position on a side of the outer ring raceway surface with respect to the end parts of the peripheral walls on the one side in the axial direction.

The grease storage groove may also be defined by a cylindrical wall (21) continuous with the outer ring raceway surface and extending along the axial direction (X) of the outer ring, and a vertical wall (22) continuous with the inner peripheral surface (18) of the outer ring and perpendicular to the cylindrical wall.

A length (L₁) of the cylindrical wall in the axial direction (X) of the outer ring may also be longer than a length (L₂) of the vertical wall in the radial direction of the outer ring.

The grease storage groove may also be formed in which a bottom part of the grease storage groove is arranged in an inward position in a radial direction (Z) of the outer ring with respect to the deepest part (15A) of the outer ring raceway surface.

The ball bearing may further include seals (6, 7) formed in both end parts of the ball bearing in the axial direction. Each of the seals may include a cylindrical part (34) extending along the axial direction (X) of the ball bearing. The outer ring may include steps (36, 37) in the inner periphery of the outer ring so as to store outer peripheral side end parts of the seals. A leading end edge (34A) of the cylindrical part may be butted against each of the steps.

An inner periphery of the cylindrical part may also be approximately flush with the inner periphery of the outer ring.

The end edge of the grease storage groove on the one side in the axial direction may also be flush with the end parts of the peripheral walls of the pocket holes on one the side in the axial direction with respect to the axial direction (X) of the outer ring.

A taper surface (102) may also be formed, which approaches inwardly in the radial direction (Z) of the retainer as being away from the pocket holes, on further one side in the axial direction than the pocket holes, on the outer peripheral surface (28) of the retainer.

Here, in the above description, numerals and so on within brackets represent the reference signs of the corresponding composing elements in the embodiments of the invention to be described below but these reference signs do not limit the scope of the patent claims.

### Effects of the Invention

According to the invention, in such portion of the inner periphery of the outer ring as exists on one side in the axial direction of the outer ring with respect to the outer ring raceway surface, there is formed the grease storage groove. Also, the grease storage groove communicates with the outer ring raceway surface. Therefore, grease stored in the grease storage groove can be smoothly supplied to the outer ring raceway surface, thereby enabling realization of excellent grease lubrication between the outer ring raceway surface and the outer peripheral surfaces of the balls. The invention can realize speedup as a grease lubrication ball bearing.

Meanwhile, on the other side in the axial direction of the outer ring with respect to the outer ring raceway surface, the grease storage groove is not formed. Therefore, since it is not necessary to provide a shoulder part by increasing the thickness on this side in order to maintain the strength, the volume of a grease sealable space between the inner and outer rings can be increased. Thus, the quantity of grease to be sealed between the inner and outer rings can be increased, whereby grease lubrication can be realized for a long period.

Also, since the end edge of the grease storage groove on one side in the axial direction is matched to the end parts of the peripheral walls of the pocket holes on one side in the axial direction or is situated on the outer ring raceway surface side with respect to the end parts of the peripheral walls on one side in the axial direction, when the area of the inner periphery of the outer ring except for the grease storage groove forms a cylindrical surface, the whole area of the outer peripheral surface of the retainer on one side in the axial direction is guised to the inner periphery of the outer ring. This can prevent occurrence of partial wear in the outer peripheral surface of the retainer on one side in the axial direction.

Thus, the invention can provide a ball bearing which can realize excellent grease lubrication over a long period and can prevent occurrence of partial wear in the outer peripheral surface of a retainer.

According to the invention, since the grease storage groove is defined by the cylindrical wall and the vertical wall perpendicular to the cylindrical wall, the volume of the grease storage groove can be increased. This can increase the quantity of grease to be stored in the grease storage groove, whereby grease lubrication in the outer ring raceway surface can be executed more excellently.

Also, since the bottom part of the grease storage groove is defined by the cylindrical wall not by a tapered surface or the like, rolling of the balls onto the bottom part of the grease storage groove can be prevented effectively.

According to the invention, the length of the vertical wall in the radial direction of the outer ring is smaller than the length of the cylindrical wall in the axial direction of the outer ring. Therefore, the grease storage groove can be formed without deepening it outward in the radial direction. Thus, rolling of the balls onto the bottom part of the grease storage groove can be prevented more effectively.

According to the invention, since the bottom part of the grease storage groove is situated more inward in the radial direction of the outer ring than the deepest part of the outer ring raceway surface, rolling of the balls onto the bottom part of the grease storage groove can be prevented effectively.

According to the invention, since the leading end edge of the cylindrical part of the seal is butted against the step formed in the inner periphery of the outer ring, invasion of grease into the step can be prevented. This can prevent grease from staying in the step, whereby the quantity of grease for grease lubrication can be increased.

According to the invention, stay of grease in the step can be prevented more positively, whereby the quantity of grease for grease lubrication can be increased further.

According to the invention, grease flowing from the outer peripheral side of the inner ring along the peripheral wall of the pocket hole on one side in the axial direction toward the inner peripheral side of the outer ring is easy to be supplied to the grease storage groove of the inner periphery of the outer ring. Thus, although the grease storage groove is formed only on one side, a large quantity of grease can be guided, with the result that grease lubrication in the outer ring raceway surface can be executed more excellently.

According to the invention, formation of the taper surface in the outer peripheral surface of the retainer can facilitate the flow of grease between the outer peripheral surface of the retainer and the inner periphery of the outer ring. As a result, a large quantity of grease can be guided to the grease storage groove, thereby enabling more excellent grease lubrication in the outer ring raceway surface. Also, formation of the taper surface in the retainer can increase the volume of a space between the inner and outer rings accordingly, thereby enabling more increase in the storing quantity of grease.

### BRIEF DESCRIPTION OF THE DRAWINGS

FIG. 1 is a section view of a ball bearing according to an embodiment of the invention.

FIG. 2 is an enlarged view of the periphery of a grease storage groove shown in FIG. 1.

FIG. 3 is a section view of a ball bearing according to another embodiment of the invention.

### MODE FOR CARRYING OUT THE INVENTION

Description is given below specifically of embodiments of the invention with reference to the drawings.

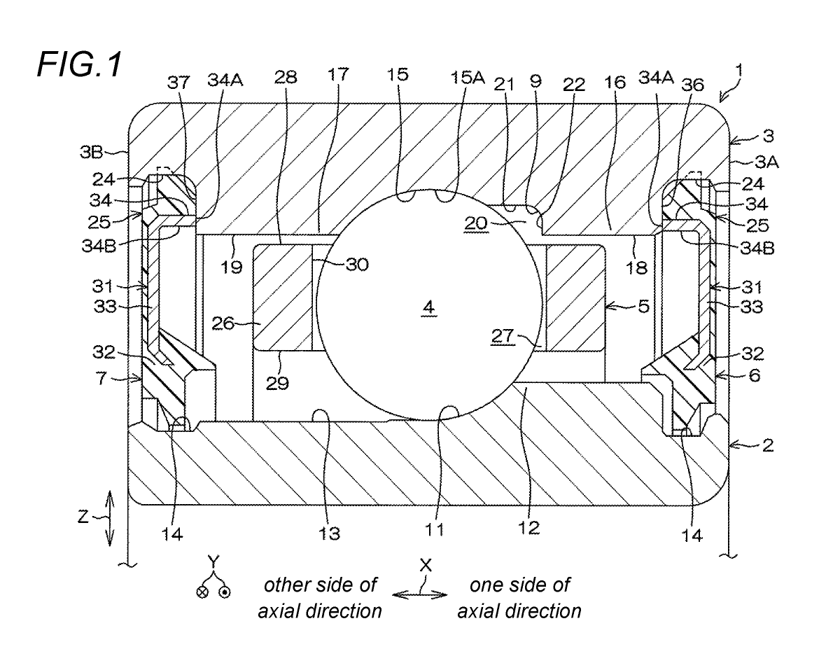

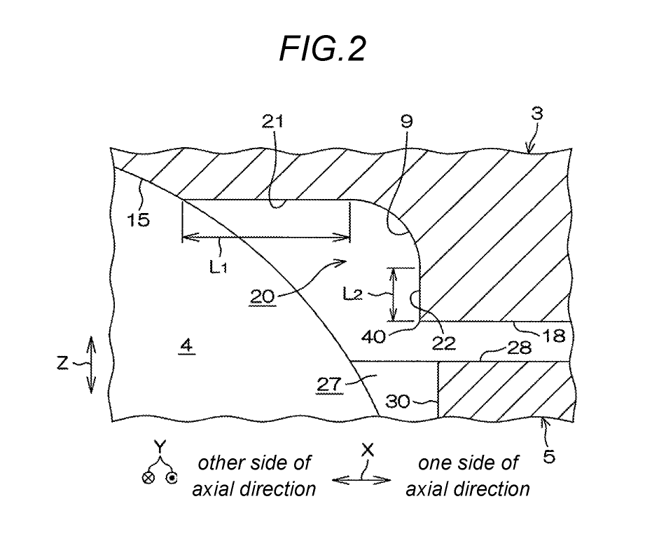

FIG. 1 is a section view of a ball bearing 1 according to an embodiment of the invention. FIG. 2 is an enlarged view of the periphery of a grease storage groove 20 of FIG. 1.

The ball bearing 1 is a ball bearing for high speed rotation which is used to support, for example, a rotation shaft (not shown) of a machine tool (not shown). The ball bearing 1 is also used as a ball bearing used to support a rotation shaft for a turbine such as a compressor or a pump other than the machine tool.

The ball bearing 1 is, for example, an angular ball bearing. The ball bearing 1 includes an inner ring 2 externally fitted with and fixed to the rotation shaft, an outer ring 3 internally fitted with and fixed to the housing (not shown) of the machine tool, a plurality of balls 4 arranged between the inner ring raceway surface 11 of the inner ring 2 and the outer ring raceway surface 15 of the outer ring 3, a cylindrical retainer 5 having pockets for holding the plurality of the balls 4 at specific intervals in the peripheral direction, a first seal 6 formed in the axial-direction one end (the right end of FIG. 1) of an annular space lying between the inner ring 2 and outer ring 3, and a second seal 7 formed in the axial-direction other end (the left end of FIG. 1) of the annular space between the inner ring 2 and outer ring 3.

In the following description, the axial direction of the rotation shaft (not shown) is defined as an axial direction X. The axial direction of the outer ring 3 and the axial direction of the retainer 5 coincide with the axial direction X. Also, for convenience, of the axial direction X, the axial direction (the right side direction of FIG. 1) of the side (the side where a contact angle is generated) on which a rolling element load in the inner ring raceway surface 11 (contact point) acts is defined as one side in the axial direction, whereas, of the axial direction X, the axial direction (the left side direction of FIG. 1) of the side (the side where a contact angle is generated) on which the rolling element load in the outer ring raceway surface 15 (contact point) acts is defined as the other side in the axial direction. Also, the radial direction of the ball bearing 1 is defined as a radial direction Z. The radial direction of the outer ring 3 coincides with the radial direction Z. In the radial direction Z, the side which approaches the rotation shaft (not shown) is defined as [an inside], whereas, in the radial direction Z, the side which moves away from the rotation shaft (not shown) is defined as [an outside]. Further, the peripheral direction of the ball bearing 1 is defined as a peripheral direction Y.

The inner ring 2 can be rotated integrally with the rotation shaft. Of the outer periphery of the inner ring 2, in the central part thereof in the axial direction X, there is formed an inner ring raceway surface 11 on which the balls 4 are allowed roll. The inner ring raceway surface 11 is formed such that a contact angle between the inner ring raceway surface 11 and balls 4 provides a predetermined angle. Of the outer periphery of the inner ring 2, on one side thereof (the right side of FIG. 1) in the axial direction X, there is formed an inner ring shoulder part 12. Also, of the outer periphery of the inner ring 2, on the other side thereof (the left side of FIG. 1) in the axial direction X specifically, on such side in the axial direction X as exists opposite the contact angle generating side (the other side of the axial direction X; the left side of FIG. 1), there is formed a counter bore 13 (a shoulder dropped part). In the two end parts of the outer periphery of the inner ring 2 in the axial direction X, there are formed first seal grooves 14 respectively recessed inward in the radial direction Z.

The outer ring 3 is fixed to the housing (not shown). Of the inner periphery of the outer ring 3, in the central part thereof in the axial direction X, there is formed an outer ring raceway surface 15 on which the balls 4 are allowed to roll. The outer ring raceway surface 15 is formed such that a contact angle between the outer ring raceway surface 15 and balls 4 provides a predetermined angle. In the inner periphery of the outer ring 3 except for the outer ring raceway surface 15, on both sides thereof in the axial direction X when viewed from the outer ring raceway surface 15, there are formed a first outer ring shoulder part 16 and a second outer ring shoulder part 17. The inner periphery of the first outer ring shoulder part 16 has an inner peripheral surface 18, while the inner periphery of the second outer ring shoulder part 17 has an inner peripheral surface 19. The inner peripheral surfaces 18 and 19 have the same diameter. That is, the peripheral surfaces 18 and 19 are cylindrical surfaces flush with each other.

In the inner periphery of the outer ring 3, there is formed a grease storage groove 20 which adjoins one side (the right side of FIG. 1) in the axial direction X of the outer ring raceway surface 15 and is used to store grease (not shown) therein. That is, the grease storage groove 20 is formed between the outer ring raceway surface 15 and first outer ring shoulder part 16. The outer ring raceway surface 15 is a groove the section of which has a substantially L-like shape and which is defined by a cylindrical wall 21 extending around the axial direction X, a vertical wall extending along the radial direction Z and a curved wall 9 (see FIG. 2) connecting the cylindrical wall 21 and vertical wall 22 to each other. The cylindrical wall 21 is continuous with the outer ring raceway surface 15. The cylindrical wall 21 constituting the bottom surface of the grease storage groove 20 is situated more inward in the radial direction Z than the deepest part 15A of the outer ring raceway surface 15. The deepest part 15A constitutes such portion of the bottom part of the outer ring raceway surface 15 as exists in the central position thereof in the axial direction X. In other words, the bottom part of the grease storage groove 20 is situated more inward in the radial direction Z than the deepest part 15A of the outer ring raceway surface 15. Since the bottom part of the grease storage groove 20 is defined not by a taper surface or the like but by the cylindrical wall 21, the ball 4 can be effectively prevented from rolling on the bottom part of the grease storage groove 20. Also, since the bottom part of the grease storage groove 20 is situated more inward in the radial direction of the outer ring 3 than the deepest part 15A of the outer ring raceway surface 15, rolling of the ball onto the bottom part of the grease storage groove 20 can be prevented effectively.

The vertical wall 22 is continuous with the inner peripheral surface 18. The length L₁ (see FIG. 2) of the cylindrical wall 21 in the axial direction X is longer than the length L₂ (see FIG. 2) of the vertical wall 22 in the radial direction Z. In other words, the length L₂ of the vertical wall 22 in the radial direction Z is smaller than the length L₁ of the cylindrical wall 21 in the axial direction X. Therefore, the volume of the grease storage groove 20 can be maintained large without deepening the grease storage groove 20 outward in the radial direction Z. Thus, rolling of the ball 4 onto the bottom part of the grease storage groove 20 can be prevented more effectively.

In the two end parts of the inner periphery of the outer ring 3 in the axial direction X, there are formed second seal grooves 24. To form the second seal groove 24 existing on one side (the right side of FIG. 1) in the axial direction X, in the inner peripheral surface 18 of the first outer ring shoulder part 16, there may be formed a first step 36 which connects together the inner peripheral surface 18 and the one side end face 3A of the outer ring 3. The first step 36 is a surface perpendicular to the inner peripheral surface 18. To form the second seal groove 24 existing on the other side (the left side of FIG. 1) in the axial direction X, in the inner peripheral surface 19 of the first outer ring shoulder part 17, there may be formed a second step 37 connecting together the inner peripheral surface 19 and the other side end face 3B of the outer ring 3. The second step 37 is a surface perpendicular to the inner peripheral surface 19. In the second seal groove 24, there is fitted the outer peripheral part 25 of its corresponding seal (first seal 6 or second seal 7).

The retainer 5 includes an annular plate-shaped retainer main body 26. In the retainer main body 26, a plurality of pocket holes 27 penetrating through the retainer main body 26 in the radial direction Z are formed at regular intervals in the peripheral direction Y. The retainer 5 is arranged such that the retainer main body 26 is coaxial with the inner ring 2. The balls 4 are arranged apiece in the pocket holes 27 of the retainer 5. In the ball bearing 1, as a method for guiding the retainer 5, there is employed an outer ring guide method in which the retainer 5 is guided by bringing the inner periphery of the outer ring 3 and the outer peripheral surface 28 of the retainer 5 into sliding contact with each other. That is, the inner peripheral surface 18 of the first outer ring shoulder part 16 and the inner peripheral surface 19 of the second outer ring shoulder part 17 are brought into sliding contact with the outer peripheral surface 28 of the retainer 5, thereby guiding the retainer 5. This can stabilize the behavior of the retainer 5 while the ball bearing 1 is rotating.

Each pocket hole 27 is defined by a peripheral wall 30 forming a cylindrical surface. As described above, by bringing the retainer 5 into sliding contact with the inner periphery of the outer ring 3, the attitude of the retainer 5 is stabilized. In this embodiment, as the retainer 5, for example, there is employed a punched retainer equipped with the pocket holes 27 formed by punching a steel plate. However, as the retainer 5, there may also be employed a machined retainer or a molded retainer.

In a state where the retainer 5 is stored within the ball bearing 1, the end of the peripheral wall 30 of the pocket hole 27 of the retainer 5 on one side in the axial direction X, with respect to the axial direction X, is substantially matched to the vertical wall 22 of the grease storage groove 20. In other words, in a state where the retainer 5 is stored within the ball bearing 1, the end of the peripheral wall 30 on one side (the right side of FIG. 1) in the axial direction X is somewhat close to one side in the axial direction X. The end edge 40 of the grease storage groove 20 on one side in the axial direction X, with respect to the axial direction X, is substantially matched to the end parts of the peripheral walls 30 of the pocket holes 27 of the retainer 5 on one side in the axial direction X. In other words, the end edge 40 is somewhat close to the outer ring raceway surface 15. As described above, since the inner peripheral surfaces 18, 19 of the first and second outer ring shoulder parts 16, 17 have cylindrical surfaces flush with each other, the whole area of the outer peripheral surface 28 of the retainer 5 on one side in the axial direction X is guided to the inner periphery of the outer ring. In other words, since the inner periphery of the outer ring 3 except for the grease storage groove 20 forms a cylindrical surface, the whole area of the outer peripheral surface 28 of the retainer 5 on one side in the axial direction X is guided to the inner periphery of the outer ring.

The paired seals 6 and 7 are used to seal an annular space between the inner ring 2 and outer ring 3 to thereby prevent grease from scattering from this annular space, and have the same specifications. In this embodiment, the seals 6 and 7 are annular non-contact seals. Here, they may also be contact seals. The seals 6 and 7 each includes an annular steel-made mandrel 31 and a seal main body 2 formed of rubber or resin with the mandrel 31 embedded therein. The mandrel 31 includes an annular plate 33 arranged to extend along the radial direction Z, and a plate-shaped cylindrical part 34 extended along the axial direction X from the outer peripheral edge of the annular plate 33. The inner part of the annular plate 33 in the radial direction Z is slightly bent so as to extend toward the other side (the left side of FIG. 1) in the axial direction X. In a state where the seals 6 and 7 are mounted on the inner ring 2 and outer ring 3, the outer peripheral parts of the seals 6 and 7 (the outer peripheral part of the seal main body 32) are fitted with the second seal groove 24 of the outer ring 3, and the leading end edges 34A of the cylindrical parts 34 of the respective mandrels 31 are butted against the steps 36 and 37. In this mounted state, the inner peripheral surfaces 34B of the cylindrical parts 34 are substantially flush with their corresponding inner peripheral surfaces 18 and 19.

Thus, since the leading end edges 34A of the cylindrical parts 34 of the mandrels 31 are butted against their corresponding steps 36 and 37, grease is prevented from invading into the second seal groove 24. Thus, grease can be prevented from staying in the second seal groove 24, thereby enabling increase in the amount of grease used for grease lubrication. Also, in this embodiment, since the inner peripheral surfaces 34B of the cylindrical parts 34 are substantially flush with their corresponding inner peripheral surfaces 18 and 19, stay of grease in the second seal groove 24 can be prevented more positively, with the result that the amount of grease for grease lubrication can be increased further.

As described above, of the outer periphery of the inner ring 2, on one side (on the right side of FIG. 1) in the axial direction X, there is formed the inner ring shoulder part 12, whereas, of the outer periphery of the inner ring 2, on the other side (on the left side of FIG. 1) in the axial direction X, there is formed the counter bore 13 (the shoulder dropped part). That is, in the inner ring 2, the diameter of the part thereof existing on the other side (on the left side of FIG. 1) in the axial direction X is smaller than that of the part thereof existing on one side (on the right side of FIG. 1) in the axial direction X. Therefore, while the inner ring 2 is rotating, due to a difference between centrifugal forces respectively acting on the two sides thereof in the axial direction X, in the outer periphery of the inner ring 2, there is generated the flow of grease that goes from the other side to one side in the axial direction X (a pumping operation). Thus, grease arranged around the outer periphery of the inner ring 2 is caused to move from the other side toward one side in the axial direction X. That is, a portion of grease arranged near the other side in the axial direction X with respect to the balls 4 moves through between the inner ring raceway surface 11 and the outer surfaces of the balls 4 toward one side in the axial direction X with respect to the balls 4, thereafter, on receiving the centrifugal force produced by the rotation of the inner ring 2, is scattered outward in the radial direction Z, and is introduced into the pocket holes 27 of the retainer 5. On receiving the centrifugal force produced by the rotation of the retainer 5, grease within the pocket holes 27 is moved within the retainer 5 along the end parts of the peripheral walls 30 of the pocket walls 27 from the inner end (the lower end parts of FIG. 1) thereof in the radial direction Z of the retainer 5 to the outer end (the upper end parts of FIG. 1) thereof in the radial direction Z. On reaching the outer end parts of the peripheral walls 30 in the radial direction Z, the grease is scattered outward in the radial direction Z due to the centrifugal force produced by the rotation of the retainer 5.

As described above, since the end parts of the peripheral walls 30 of the pocket holes 27 of the retainer 5 on one side in the axial direction X are substantially matched to the vertical wall 22 of the grease storage groove 20, grease scattered from the end parts of the peripheral walls 30 of the pocket holes 27 of the retainer 5 on one side in the axial direction X is supplied to and stored in the grease storage groove 20. Also, grease not passing within the pocket holes 27 of the retainer 5 flows through between the inner peripheral surface 29 of the retainer 5 and inner ring 2 and, after then, on receiving a centrifugal force, is caused to flow through a space between the retainer 5 and first seal 6 outward in the radial direction Z toward the inner peripheral surface 18 of the outer ring 3. A portion of such grease flows through a clearance between the inner peripheral surface 18 and retainer 5 (except for the guide part (contact part) between the inner peripheral surface 18 and retainer 5) to the grease storage groove 20 and is stored therein. Grease stored in the grease storage groove 20 is supplied between the outer ring raceway surface 15 and the outer surfaces of the balls 4.

Also, when sealing grease, preferably, the grease may be applied mainly to the outer peripheral surface of the inner ring 2 opposed to the inner peripheral surface 29 of the retainer 5 in the radial direction Z.

As described above, according to this embodiment, the grease storage groove 20 is formed in such portion of the inner periphery of the outer ring 3 as exists on one side (the right side of FIG. 1) in the axial direction X with respect to the outer ring raceway surface 15. Also, the grease storage groove 20 communicates with the outer ring raceway surface 15. Therefore, grease stored in the grease storage groove 20 can be supplied smoothly to the outer ring raceway surface 15, thereby enabling realization of excellent grease lubrication between the outer ring raceway surface 15 and the outer surfaces of the balls 4.

Meanwhile, in such portion of the inner periphery of the outer ring 3 as exists on the other side (the left side of FIG. 1) in the axial direction X with respect to the outer ring raceway surface 15, the grease storage groove 20 is not formed. Therefore, since there is no need to provide, in the inner periphery of the outer ring 3 on the other side in the axial direction, a groove forming shoulder part by increasing the thickness thereof in order to maintain the strength thereof, the volume of a grease sealable space between the inner and outer rings 2 and 3 can be increased. Thus, the quantity of grease to be sealed between the inner and outer rings 2 and 3 can be increased, whereby excellent grease lubrication between the outer ring raceway surface 15 and the outer surfaces of the balls 4 can be realized more positively.

Also, since the end edge 40 of the grease storage groove 20 on one side in the axial direction X is substantially matched, with respect to the axial direction X, to the end parts of the peripheral walls 30 of the pocket holes 27 on one side in the axial direction X, the whole area of the outer peripheral surface 28 of the retainer 5 on one side in the axial direction X is guided to the inner periphery of the outer ring. Thus, occurrence of partial wear in the outer peripheral surface 28 of the retainer 5 on one side in the axial direction X can be prevented.

As described above, this embodiment can provide the ball bearing 1 which can realize excellent grease lubrication over a long period and also can prevent occurrence of partial wear in the outer peripheral surface 28 of the retainer 5. Thus, the ball bearing 1 can realize high-speed grease lubrication.

Also, since the end edge 40 of the grease storage groove 20 on one side in the axial direction X is, with respect to the axial direction X, substantially matched to the end parts of the peripheral walls 30 of the pocket holes 27 of the retainer 5 on one side in the axial direction X, grease flowing from the outer periphery of the inner ring 2 along the end of the peripheral walls 30 of the pocket holes 27 in the axial direction X toward the inner peripheral side of the outer ring 3 is easy to be supplied to the grease storage groove 20 of the inner periphery of the outer ring 3. Thus, a large amount of grease can be guided to the grease storage groove 20, with the result that grease lubrication in the outer ring raceway surface 15 can be executed more excellently.

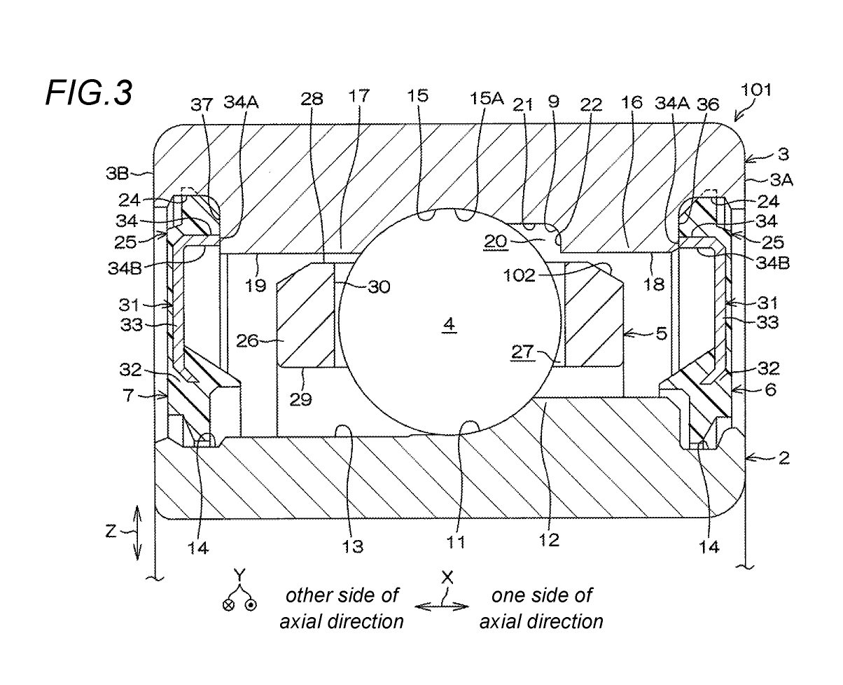

FIG. 3 is a section view of a ball bearing 101 according to another embodiment of the invention.

In the embodiment of FIG. 3, the composing parts thereof equivalent to those of the embodiment of FIGS. 1 and 2 are given the same reference designations and thus the description thereof is omitted here.

The ball bearing 101 is different from the ball bearing 1 according to the above embodiment in that an annular taper surface 102 is formed over the whole area of the outer peripheral surface 28 of the retainer main body 26 of the retainer 5 in the peripheral direction Y. The taper surface 102 is arranged in such portion of the outer peripheral surface 28 as exists, with respect to the axial direction X, further on one side in the axial direction X than the one-side end parts of the a plurality of pocket holes 27 in the axial direction X. The taper surface 102 is a taper surface which goes inward in the radial direction Z as it moves away from the pocket holes 27.

Such formation of the taper surface 102 in the outer peripheral surface 28 of the retainer 5 facilitates the flow of grease between the outer peripheral surface 28 of the retainer 5 and the inner periphery of the outer ring 3. Specifically, grease flowing through a space existing between the retainer 5 and first seal 6 outward in the radial direction toward the inner peripheral surface 18 of the outer ring 3 is easy to flow along the taper surface 102 of the retainer 5. Thus, between the inner peripheral surface 18 of the outer ring 3 and the outer peripheral surface 28 of the retainer 5, the flow of grease going toward the grease storage groove 20 is easy to occur. Also, since the outer peripheral surface 28 of the retainer 5 includes the taper surface 102, the contact area of the outer peripheral surface 28 of the retainer 5 to be contacted with and guided by the outer ring 3 is reduced. Therefore, in this respect as well, grease is easy to flow through between the inner peripheral surface of the outer ring 3 and the outer peripheral surface 28 of the retainer 5. Further, by forming the outer peripheral surface 28 of the retainer 5 as a taper surface, a space between the outer ring 3 and inner ring 2 becomes larger accordingly. Thus, the quantity of grease to be sealed in the initial stage can be increased. Therefore, the quantity of grease to be stored in the grease storage groove 20 can be increased and the supply of grease to the grease storage groove 20 is hard to be interrupted, thereby enabling long-period supply of grease between the balls 4 and outer ring raceway surface 15. That is, excellent grease lubrication can be realized for a longer period.

In this embodiment, the grease storage groove 20 is formed only on one side of the inner peripheral surfaces 18, 19 of the outer ring. Therefore, in comparison with a case where the grease storage grooves 20 are formed on both sides, when grease supply is interrupted even a little, it is difficult to maintain a state where grease is stored within the grease storage groove 20. This raises a fear that poor lubrication such as seizure can occur. Formation of the outer peripheral surface 28 of the retainer 5 in a tapered shape is very effective in realizing the stable supply of grease to the grease storage groove 20 even when the grease storage groove 20 is formed only on one side.

Although description has been given heretofore of the two embodiments of the invention, the invention can also be enforced in other embodiments.

For example, in the above two embodiments, as the ball bearing 1, 101, there is employed an angular ball bearing. However, instead of this, there may also be employed a deep-groove ball bearing.

Also, in the above two embodiments, description has been given of an example in which the inner ring 2 provides the rotation side to be rotated following the rotation shaft and the outer ring 3 provides the fixed side. However, the invention can also apply to a case where the outer ring 3 provides the rotation side and the inner ring 2 provides the fixed side.

Further, various changes are also possible without departing from the scope of the patent claims.

### INDUSTRIAL APPLICABILITY

The invention can provide a ball bearing which can realize excellent grease lubrication over a long period and can prevent occurrence of partial wear in the outer peripheral surface of a retainer.

### DESCRIPTION OF REFERENCE NUMERALS AND SIGNS

1: Ball bearing
2: Inner ring
3: Outer ring
4: Ball
5: Retainer
6: First seal
7: Second seal
11: Inner ring raceway surface
15: Outer ring raceway surface
15A: Deepest part
18: Inner peripheral surface
20: Grease storage groove
21: Cylindrical wall
22: Vertical wall
27: Pocket hole
28: Outer peripheral surface
30: Peripheral wall
34: Cylindrical part
34A: Leading end edge
36: First step
37: Second step
40: End edge of grease storage groove on one side in axial direction
101: Ball bearing
102: Taper surface
L₁: Length of cylindrical wall in axial direction
L₂: Length of vertical wall in radial direction of outer ring
X: Axial direction
Y: Peripheral direction
Z: Radial direction

1-8. (canceled)

9. A ball bearing comprising: an inner ring including an inner ring raceway surface on an outer periphery; an outer ring including an outer ring raceway surface on an inner periphery; a plurality of balls arranged between the inner ring raceway surface and the outer ring raceway surface; and a retainer including a plurality of pocket holes which respectively store the plurality of the balls, and arranged between the inner ring and the outer ring, wherein grease is sealed between the inner ring and the outer ring, wherein the inner periphery of the outer ring is contacted with outer peripheral surface of the retainer so as to guide the retainer, wherein the inner periphery of the outer ring includes a grease storage groove which stores the grease therein, only on one side in an axial direction of the outer ring with respect to the outer ring raceway surface, wherein the grease storage groove communicates with the outer ring raceway surface, and wherein an end edge of the grease storage groove on the one side in the axial direction is flush with end parts of peripheral walls of the plurality of the pocket holes on one side in the axial direction, or arranged in a position on a side of the outer ring raceway surface with respect to the end parts of the peripheral walls on the one side in the axial direction.

10. The ball bearing according to claim 9, wherein the grease storage groove is defined by a cylindrical wall which is continuous with the outer ring raceway surface and which extends along the axial direction of the outer ring, and a vertical wall which is continuous with the inner peripheral surface of the outer ring without the outer ring raceway surface and perpendicular to the cylindrical wall.

11. The ball bearing according to claim 10, wherein a length of the cylindrical wall in the axial direction of the outer ring is longer than a length of the vertical wall in a radial direction of the outer ring.

12. The ball bearing according to claim 9, wherein the grease storage groove is formed so that a bottom part of the grease storage groove is arranged in an inward position in a radial direction of the outer ring with respect to the deepest part of the outer ring raceway surface.

13. The ball bearing according to claim 9, wherein the ball bearing further comprises seals formed in both end parts of the ball bearing in the axial direction, wherein each of the seals includes a cylindrical part extending along the axial direction of the ball bearing, wherein the outer ring includes steps in the inner periphery of the outer ring so as to store outer peripheral side end parts of the seals, and wherein a leading end edge of the cylindrical part is butted against each of the steps.

14. The ball bearing according to claim 13, wherein an inner periphery of the cylindrical part is approximately flush with the inner periphery of the outer ring.

15. The ball bearing according to claim 9, wherein the end edge of the grease storage groove on the one side in the axial direction is flush with the end parts of the peripheral walls of the plurality of the pocket holes on the one side in the axial direction with respect to the axial direction of the outer ring.

16. The ball bearing according to claim 9, wherein a taper surface is formed, which approaches inwardly in the radial direction of the retainer as being away from the plurality of the pocket holes, on further one side in the axial direction than the pocket holes, on the outer peripheral surface of the retainer.
